(19) United States
(12) Patent Application Publication
(10) Pub. No.: US 2016/0098820 A1
(43) Pub. Date: Apr. 7, 2016

(54) SYSTEM FOR ROBUST DENOISING OF IMAGES

(71) Applicant: RAGHU KOPALLE, ALBUQUERQUE, NM (US)

(72) Inventors: FABRICE ROUSSELLE, MONTREAL (CA); MATTHIAS ZWICKER, BERN (CH); MARCO MANZI, BERN (CH)

(21) Appl. No.: 14/506,238

(22) Filed: Oct. 3, 2014

(51) Int. Cl. G06T 5/00; G06T 5/20; G06T 19/20; G06T 15/00; G06T 15/50

(52) U.S. Cl. CPC G06T 5/002; G06T 15/005; G06T 15/50; G06T 19/20; G06T 5/20; G06T 2219/2012; G06T 2207/20028; G06T 2207/20182

(57) ABSTRACT

The invention produces a higher quality image from a rendering system based on a relationship between the output of a rendering system and the parameters used to compute them. We propose a method that robustly combines color and feature buffers to denoise Monte Carlo renderings. On one hand, feature buffers, such as per pixel normals, textures, or depth, are effective in determining denoising filters because features are highly correlated with rendered images. Filters based solely on features, however, are prone to blurring image details that are not well represented by the features. On the other hand, color buffers represent all details, but they may be less effective to determine filters because they are contaminated by the noise that is supposed to be removed. We propose to obtain filters using a combination of color and feature buffers in an NL-means and cross-bilateral filtering framework. We determine a robust weighting of colors and features using a SURE-based error estimate. We show significant improvements in subjective and quantitative errors compared to the previous state-of-the-art. We also demonstrate adaptive sampling and space-time filtering for animations.

### BACKGROUND OF THE INVENTION

1. Field of the Invention

The invention relates generally to computer graphics. More particularly, the invention relates to a system and methods for image rendering in and by digital computing systems, such as computer graphics systems and methods for motion pictures, TV shows, visual effects and other applications.

2. Description of Prior Art

Image space filtering techniques are often inspired by denoising algorithms from the image processing research community, adapted to the specifics of Monte Carlo rendering. While there are several proposed methods that rely on color samples obtained from Monte Carlo renderers, filtering quality can be greatly improved by exploiting auxiliary per pixel information called “Features”. Examples of features include per pixel normal, depth or texture.

Bauszat P, Eisemann M, Magnor M.: Guided image filtering for interactive high-quality global illumination. Computer graphics forum (Proc. of Eurographics Symposium on Rendering (EGSR)) 30,4 (June 2011), 1361-1368.

He K. Sun J. Tang X: Guided image filtering. In proceedings of the 11^{th} European Conference on Computer vision: Part I (Berlin, Heidelberg, 2010), ECCV′10, Springer-Verlag, pp. 1-14.

Dammertz H., Sewtz D, Hanika J., Lensch H: Edge-avoiding a-trous wavelet transform for fast global illustration filtering. In Proceedings of the conference on High Performance Graphics (2010), Eurographics Association, pp. 67-75.

The disadvantage of the above three techniques is that they assume that features are not corrupted by noise.

Current state-of-the-art in off-line rendering combines feature-based filters with error estimation techniques to drive adaptive sampling, and includes approaches to deal with noisy features.

U.S. Pat. No. 8,712,180 B2, by Sen P., Darabi, S; System and Methods for Random Parameter Filtering. This approach uses an information theoretic approach to deal with noisy features, based on cross-bilateral filtering proposed by Eisemann E., Durand F.: Flash photography enhancement via intrinsic relighting.

US patent application publication # US20140098098 A1, by Julien Chauvier, Mauricio Delbracio, Nicholas Phelps; Method for Accelerating Monte Carlo Renders

Li T, Wu. Y. and Chuang Y. in their paper titled “Sure-based optimization for adaptive sampling and reconstruction” ACM Trans. Graph. 31, 6 (Nov. 2012), 194:1-194:9. This method combined a per-pixel SURE-based error estimate based on cross-bilateral filter proposed by Stein C. M. titled “Estimation of the mean of a multivariate normal distribution”.

Van De Ville and Kocher proposed “a SURE-based nonlocal means. Signal Processing Letters, IEEE 16,11 (2009), 973-976. This method uses error estimate for parameter selection on a per-image rather than per-pixel basis

Moon B., Jun J. Y., Kim K., Hachisuka T., Yoon S., Robust image denoising using a virtual flash image for Monte Carlo Ray Tracing. Computer Graphics Forum 32,1 (2013), 139-151. Moon et al. apply an NL-means filter guided by a virtual flash image.

Filtering based on feature buffers, such as per pixel normal, texture, or depth, has proven extremely effective, in particular for images rendered with very few samples per pixel and high noise levels in the Monte Carlo output. On the other hand, image details that are not represented in the feature buffers tend to be blurred by such approaches. Compared to these prior arts, our unique method finds a trade-off between driving the filter using color or feature information. We de-noise features in a separate step, which allows us to effectively exploit novel features such as direct light source visibility or caustics that tend to be noisy. Finally we add a second filtering pass based on a variance estimate of the first pass to produce significant quality improvements.

### SUMMARY OF THE INVENTION

Monte Carlo rendering suffers from noise artifacts that can often only be avoided by sampling an excessive number of light paths. This has slowed the adoption of Monte Carlo rendering in applications ranging from movie production to real-time rendering. While a vast variety of variance reduction and sophisticated sampling techniques have been proposed for Monte Carlo rendering, a renewed interest in image space filtering methods has shown that such methods can be surprisingly effective. These methods are appealing because they are relatively easy to implement, mostly orthogonal to other variance reduction techniques, applicable to general light transport effects, computationally efficient, and often competitive with more specialized approaches targeting specific rendering effects.

A particularly successful idea is to use feature buffers, such as per pixel normals, textures, or depth, to compute de-noising filter weights. Feature buffers are highly correlated with the rendered image, since they represent most edges in the image, but they are usually much less noisy than the color output of the Monte Carlo renderer. Therefore, filters based on feature buffers effectively remove noise while preserving most edges. Unfortunately, they are prone to blurring image details that are not well represented by the features. Feature buffers have been used to determine de-noising filters in the context of guided image filtering, which is based on local regression, wavelet thresholding, and cross-bilateral filtering.

We present a method to robustly combine color and feature buffers to improve de-noising performance. We use a filtering framework based on NL-means filter weights for color buffers and bilateral weights for feature buffers. We control the influence of color and feature buffers by adjusting the parameters of the NL-means and bilateral filters. To combine color and feature information, we evaluate three candidate filters using different parameters designed to provide a trade-off between fidelity to image detail and robustness to noise. Then we compute a weighted average of the candidate filters on a per-pixel basis using a SURE-based error estimate to minimize the output error. We deal with noisy features by de-noising them first in a separate step using an NL-means filter. This allows us to include novel features, such as a caustics buffer, and a direct visibility feature. We demonstrate that our approach leads to significant improvements both in subjective and quantitative errors compared to the previous state-of-the-art.

In summary, we make the following contributions:
a) We propose to combine color and feature buffers to improve image space de-noising of Monte Carlo renderings.
b) We implement this idea based on NL-means and cross bilateral filtering, and a SURE-based error estimate.
c) We propose to deal with noisy features by de-noising them in a separate step. This allows us to introduce novel features such as caustics and direct visibility.
d) We demonstrate significant subjective and numerical improvements in image quality over the previous state-of-the-art.
e) We extend our approach to adaptive sampling and space-time filtering for animations.

### BRIEF DESCRIPTION OF THE DRAWINGS

Various embodiments of the invention are disclosed in the following detailed description and accompanying drawings.

FIG. 1 Illustration of our rendering system that uses a balance of color and feature information.

FIG. 2 Basic equations and table of notations for the invention

FIG. 3 Our Algorithm Pseudocode

FIG. 4 A sample computing system that may be used to implement the methods according to the invention.

### DETAILED DESCRIPTION OF THE INVENTION

### 1. Definitions

“Adaptive sampling” is defined as the automatic sending of additional samples in cases where the default number of samples is deemed inadequate to achieve the desired accuracy;

“Algorithm” is defined as a method that is fully described in a procedure or computer program;

“Animation” walk-through, scene animation) is defined as a sequence of images rendered from the same scene description and lighting but from a changing view point, direction, and so on; Scene animation occurs when the actual scene geometry, materials, and/or lighting are changing with each frame;

“Animation path” is defined as the sequence of view positions and directions in a walk-through animation;

“Anisotropic” is defined as a reflection or transmission distribution function (BRTDF) that varies with rotation about the surface normal. Examples of anisotropic reflection include varnished wood with noticeable grain, brushed metal, and combed hair;

“Antialiasing” is defined as any technique that reduces sampling artifacts in the final image, particularly “jaggies” caused by abrupt changes in scene geometry;

“Array transform” is defined as a type of transform in which an object is repeated at multiple positions;

“BRDF” (bidirectional reflectance distribution function) is a mathematical function that describes the way light is reflected from a point on a locally planar surface;

“BRTDF” (bidirectional reflectance transmittance distribution function) is also known as the bidirectional scattering distribution function (BSDF), which describes the way light is transmitted and reflected by a locally planar surface; All are functions of four angles (two incident and two scattered) and return units of 1/steradian;

“Caustics or caustic shading” is defined as a visual effect seen when light is reflected off a specular or reflective surface, or focused through a refractive surface, so that it indirectly illuminates other surfaces with focused light patterns; In 3D graphics, caustics are rendered as a type of global illumination, often using Photon Mapping or Bi-directional Raytracing techniques;

“Features” are defined as auxiliary per pixel information of an image, such as per pixel normal, depth or texture;

“Filter” is defined as any program that processes a picture and produces a modified picture as its output; Programs that take more than one input picture are sometimes included in this category, but should probably be called something more general, such as image processors;

“Monte Caro methods (or Monte Carlo experiments)” are a broad class of computational algorithms that rely on repeated random sampling to obtain numerical results; typically one runs simulations many times over in order to obtain the distribution of an unknown probabilistic entity; The name comes from the resemblance of the technique to the act of playing and recording results in a real gambling casino; They are often used in physical and mathematical problems and are most useful when it is difficult or impossible to obtain a closed-form expression, or infeasible to apply a deterministic algorithm;

“Non-local means [NL-means]” is defined as an algorithm in image processing for image denoising. Unlike “local mean” filters which take the mean value of a group of pixels surrounding a target pixel to smooth the image, non-local means filtering takes a mean of all pixels in the image, weighted by how similar these pixels are to the target pixel. This results in much greater post-filtering clarity, and less loss of detail in the image compared with local mean algorithms.

“outlier” is defined as an observation point that is distant from other observations; An outlier may be due to variability in the measurement or it may indicate experimental error; the latter are sometimes excluded from the data set.

“Pixel” is short for “picture element”. The smallest measured, calculated, or displayed point in an image.

“Rendering” is the process of creating a 2D image from a 3D representation. Also, the term given to the resulting synthetic image.

“SURE (Stein's unbiased risk estimate)” an unbiased estimator of the mean-squared error of “a nearly arbitrary, nonlinear biased estimator”; In other words, it provides an indication of the accuracy of a given estimator; This is important since the true mean-squared error of an estimator is a function of the unknown parameter to be estimated, and thus cannot be determined exactly.

“CGI” is defined as “Computer generated imaging”.

“VFX” is defined as “Visual Effects”.

“CAD/CAM” CAD is defined as “Computer Aided Design” and “CAM” is defined as “Computer Aided Manufacturing”.

“spatiotemporal” is defined an attribute existing or relating to both space and time.

“CPU” is defined as “Central Processor Unit”.

“GPU” is defined as “Graphics Processor Unit”.

### 2. Best Mode of the Invention

Our method provides significant improvements in terms of speed, visual quality and numerical quality over the previous state-of-the-art in computer graphics/animation off-line rendering methods that use Monte Carlo techniques. The primary mode of the invention is for movies, TV shows, computer generated imaging, visual effects, advertisements, pre-rendering for gaming, CAD/CAM design rendering and similar applications. While the computational cost for off-line rendering is insignificant, the technique is not very suitable for interactive rendering.

### 3. How to Make the Invention

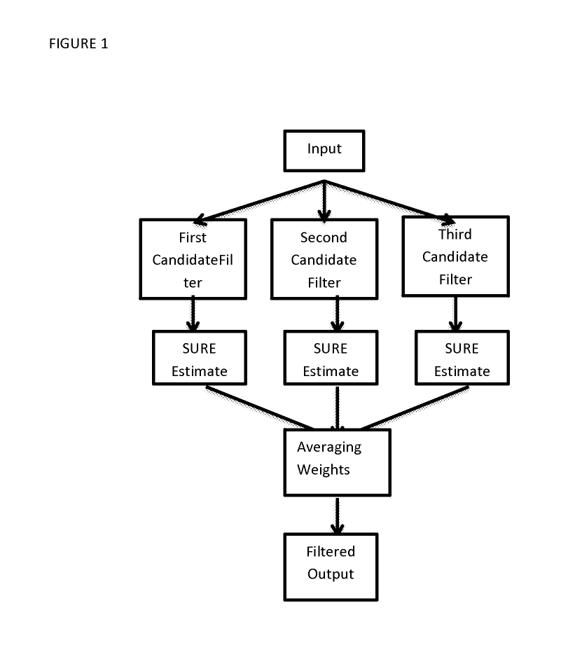

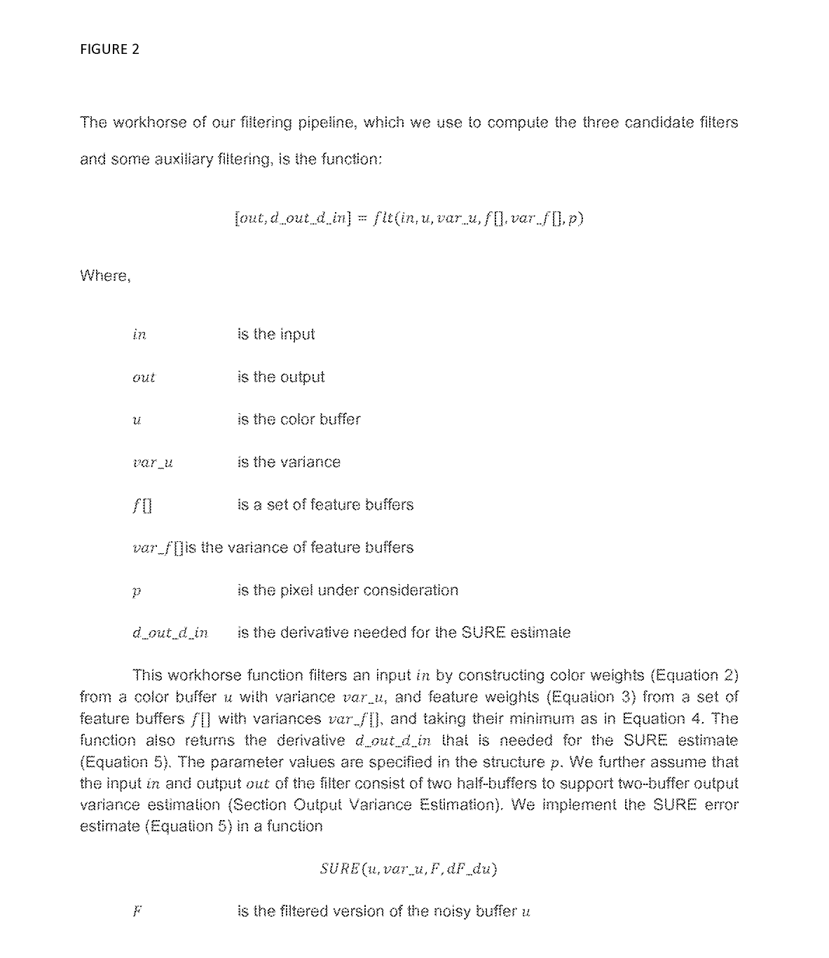

The main idea of this invention is to construct a filter that implement a balance between filtering using color and feature information. In general, our filter computes a weighted average of neighboring pixels. The filtered color values F(p)=(F1(p);F2(p);F3(p)) of a pixel p in a color image u(p)=(u1(p);u2(p);u3(p)) are

$${F}_{i} ( p ) = \frac{1}{C ( p )} {\sum }_{q ∈ N ( p )} {u}_{i} ( q ) w ( p , q ) , \qquad ( 1 )$$

where N(p) is a 2r+1×2r+1 square neighborhood centered on p, w(p,q) is the weight of the contribution of neighboring pixel q to p, i is the index of the color channel, and C(p)=Σ_{q∈N(p)}w(p,q) is a normalization factor. The fundamental challenge is to determine suitable weights w(p,q). In our approach, illustrated in FIG. 1, we construct three candidate filters, which we call the FIRST, SECOND, and THIRD candidate filter. We design the filters such that the FIRST filter is most sensitive to details in the color buffer, but also most sensitive to its noise; the THIRD filter is least sensitive to noise in the colors, but also least sensitive to its details; and the SECOND filter is in between. Then we compute the final filter as a weighted average of the candidate filters using a SURE-based per-pixel error estimate. We build the candidate filters from two types of weights, called color and feature weights. We obtain the color weights as NL-means weights from the noisy color output of the Monte Carlo renderer. We compute the feature weights as bilateral weights from the feature buffers. Then we construct the FIRST, SECOND, and THIRD candidate filters from the color and feature weights, and then compute the candidate filter averaging weights using SURE error estimation.

NL-Means Weights From Color Buffer

Our color weights we are based on NL-means filtering, which has proven effective for denoising Monte Carlo renderings because it can easily be generalized to spatially varying variances typical in such data. We compute the NL-means weights from the noisy color output of the Monte Carlo renderer, and per-pixel variance estimates.

NL-Means Weights. NL-means weights for a pixel p and a neighbor q are determined based on the distance d_{c}²(P(p)), P(q)) between a pair of small patches P(p), P(q) of size 2f+1×2f+1, centered at p and q,

$${d}_{c}^{2} ( P ( p ) , P ( q ) ) = \frac{1}{3 {( 2 f + 1 )}^{2}} {\sum }_{i = 1}^{3} {\sum }_{n ∈ P ( 0 )} {Δ}_{i}^{2} ( p + n , q + n ) ,$$

where Δ²(p+n, q+n) is a per-pixel distance in color channel i and n∈P(0) are the offsets to each pixel within a patch. We follow the approach by Rousselle et al. and define the per-pixel distance as

$${Δ}_{i}^{2} ( p , q ) = \frac{{( {u}_{i} ( p ) - {u}_{i} ( q ) )}^{2} - ( {Var}_{i} [ p ] + {Var}_{i} [ q , p ] )}{ɛ + {k}_{c}^{2} ( {Var}_{i} [ p ] + {Var}_{i} [ q ] )} .$$

The term (ui(p)−ui(q))² measures the squared difference between the color values at pixels p and q. Since ui(p) and ui(q) are noisy this consistently overestimates the true squared difference. Hence, we subtract a variance cancellation term (Varᵢ[p]+Varᵢ[q, p]) to remove this bias, similar as proposed originally for NL-means, where Varᵢ[p] is a variance estimate for the sample mean in pixel p, and Varᵢ[q, p]=min(Varᵢ[q], Varᵢ[p]. The denominator ε+k_{c}²(Varᵢ[q], Varᵢ[p]) is a normalization factor, where ε is a small value to prevent division by zero, and k_{c} is a user specified factor that controls the sensitivity of the filter to color differences. Larger values of kc lead to more aggressive filtering. Finally, we obtain our color filter weight wc(p, q) of the contribution of pixel q to p using an exponential kernel,

w_{c}(p,q)=exp^{-max(0,d}^{_{c}}^{²}^{(P(p),P(q)))}. (2)

Variance Estimation. In the case of random sampling, we could estimate the variances Varₗ of pixel means simply by considering the sample variance within each pixel. This approach is not suitable, however, to support low-discrepancy sampling where it will consistently overestimate the variance. Rousselle et al. address this problem by splitting the noisy color samples into two half-buffers and computing the empirical variance of these half-buffers. While this is an unbiased estimate of the pixel variance, it is also very noisy and leads to poor NL-means filtering performance if used directly. To address this, we observe that the sample variance exhibits the detailed structure of the actual spatially non-uniform variance, but with a systematic bias. Hence we attempt to remove this bias by simply scaling the sample variance to match the magnitude of the two-buffer variance. We smooth both the sample variance and the two-buffer variance with a large, 21×21 box filter and then compute the ratio between the two on a per-pixel basis. We then apply this ratio on the initial unfiltered sample variance. This results in a variance estimate with the lower noise of the sample variance, and the correct magnitude of the two-buffer variance.

Cross-Bilateral Weights From Feature Buffers

We determine the feature weights w_{f} using the feature buffers and bilateral weights. An important distinction compared to previous work exploiting feature buffers is that we deal with noisy features by first prefiltering them separately. We next describe our feature prefiltering technique, and then the computation of the bilateral weights using the prefiltered features.

Feature Prefiltering. Our prefiltering approach exploits the fact that features can be denoised effectively because their dynamic range, and hence their variance, is typically limited. We apply an NL-means filter as described in the previous section including the same method to estimate the input variance, although using individual features instead of color as input. We choose window radius r=5, patch radius f=3, and sensitivity k_{c}=1,0 for all features.

Output Variance Estimation. To determine the bilateral weights we will also require the residual variance of the prefiltered features, that is, we need the per-pixel variance of the prefiltered output. We obtain the output variance using a two-buffer approach similar to NL-means Weights from color buffer. We split the feature data into two half-buffers that we both filter using the same NL-means weights determined from the complete data, as described above. Note that given fixed weights, the filter (see Equation 1) is linear, and averaging the filtered half-buffers is equivalent to filtering the full data. By processing the half buffers, however, we can estimate the residual per-pixel variance as the squared per-pixel difference between the filtered half-buffers. We further reduce noise in this two-buffer variance estimate by smoothing it with a small Gaussian kernel with standard deviation of 0.5 pixels.

Bilaterai Weights. We denote feature buffers such as normals, textures, or depth, denoised and normalized to unit range, as f j. The feature distance Φⱼ²(p, q) for feature j between pixels p and q is based on the squared feature difference including variance cancellation similar to described in Section NL-means Weights from color buffer.

$${Φ}_{j}^{2} ( p , q ) = \frac{{( {f}_{j} ( p ) - {f}_{j} ( q ) )}^{2} - ( {Var}_{j} [ p ] + {Var}_{j} [ p , q ] )}{{k}_{f}^{2} max ( τ , max ( {Var}_{j} [ p ] \cdot {‖ {Grad}_{j} [ p ] ‖}^{2} ) )}$$

normalized by two factors: First, the user parameter k_{c} controls the sensitivity of the filter to feature differences. The second factor depends on the residual variance of the prefiltered feature (as described above) denoted by Varⱼ[p] and the squared gradient magnitude ∥Gradⱼ[p]∥², thresholded to a minimum value τ. This factor normalizes the feature distance relative to residual noise left in the filtered feature and the local feature contrast, measured by its gradient magnitude. Finally, we obtain an overall distance d_{f}(p, q) by taking the maximum distance over all M features,

$${d}_{f}^{2} ( p , q ) = {argmax}_{j ∈ [ 1 … M ]} {Φ}_{j}^{2} ( p , q ) ,$$

and the final feature weight w_{f(p,q)} is obtained using an exponential kernel, similar as described in Section NL-means Weights from color buffer,

w_{f}(p,q)=exp^{-d}^{_{f}}^{²}^{(p,q)}. (3)

The benefit of our feature prefiltering step is as follows on a scene with depth of field. With prefiltering, we effectively remove noise in out-of-focus regions, while preserving detail otherwise. Feature prefiltering allows us to exploit novel types of features that tend to be too noisy to be useful without prefilteing. We define a caustics feature as the per-pixel density of caustic photons. We also introduce a direct illumination visibility feature as the fraction of shadow rays that hit any light source over all direct shadow rays evaluated in a pixel. We consider the feature gradient in the distance normalization to improve filtering performance. Without the gradient term feature weights along edges are too restrictive, preventing effective filtering.

Filter Weighting Using SURE-Based Error Estimate

We use a SURE-based approach to estimate the mean squared error (MSE) of three candidate filters, which we design to provide a trade-off between fidelity to image detail and robustness to noise. We then leverage the error estimate to compute a weighted average of the candidate filters minimizing the error on a per-pixel basis. We next describe the candidate filters, the SURE-based error estimate, and the computation of the per-pixel filter averaging weights.

Candidate Filters. Our FIRST, SECOND, and THIRD candidate filters differ in their color sensitivity k_{c} and patch radius f. The FIRST filter uses k_{c}=0.45 and a small patch radius of f=1, which makes it sensitive to small image detail but also less robust to noise. The SECOND filter is the same except that it uses a larger patch radius f=3. Hence it is more robust to noise but less effective at filtering intricate image detail at low noise levels. The THIRD filter has k_{c}=∞, which means that the color information does not influence the filter weights and the patch size f is irrelevant. This filter is most robust towards noise since its weights completely ignore color information. However, it fails to recover image detail that is not represented in the features. All filters use feature sensitivity k_{f}=0.6 and the same window radius r, which is the only parameter we expose to the user. We determine the final filter weights by taking the minimum of the color and feature weights, that is

w(p,q)=min(w_{c}(p,q), w_{f}(p,q)). (4)

SURE Error Estimate. We explain the SURE error estimate by extending our notation from Equation 1 for a generic color image filter. Let us interpret the output kᵤᵢ(p) of the filter at pixel p as a function of the noisy value ui of color channel i at p. The SURE error estimator at pixel p is then

$$SURE ( p ) = {\sum }_{i = 1}^{3} {‖ {F}_{{u}_{i}} ( p ) - {u}_{i} ‖}^{2} - {σ}_{i}^{2} + 2 {σ}_{i}^{2} \frac{d {F}_{{u}_{i}} ( p )}{d {u}_{i}} \qquad ( 5 )$$

where σᵢ² is the true variance of the pixel mean of color channel i. Since our color weights w_{c} include discontinuous terms, they are technically not differentiable. But we found that a finite difference approximation of the derivatives still leads to reliable error estimates in practice, Hence we approximate dFᵤᵢ(p)/dᵤᵢ(p) as,

$$\frac{d {F}_{{u}_{i}} ( p )}{d {u}_{i}} \approx \frac{{F}_{{u}_{i}} + δ ( p ) - {F}_{{u}_{i}} ( p )}{δ} , where δ = 0.01 \times {u}_{i} .$$

Candidate Filter Averaging. While SURE provides an unbiased error estimate, it is very noisy and needs to be filtered for per-pixel error minimization. A straightforward approach would be to spatially smooth the error estimate until its variance is low enough to reliably determine the best candidate filter on a per-pixel basis. Unfortunately, in our typical data the SURE estimate tends to be contaminated by strong outliers. This requires large spatial smoothing filters, introducing bias in the per-pixel error estimates.

Instead, we achieved better results with a two-step strategy that is more robust to outliers in the initial error estimate. In a first step, we smooth the error estimate with a small kernel and obtain three binary selection maps for the candidate filters, containing a 1 in each pixel if the filter had lowest error, and 0 otherwise. Since the FIRST candidate filter is most sensitive to noise it may occur that it preserves noise, but the SURE estimate does not register the error. We avoid such residual noise by selecting the FIRST candidate only if it filters more than the SECOND, that is, the derivative term in the SURE estimate is lower for the FIRST candidate. In the second step we smooth the binary maps with a larger kernel. This approach has the advantage that the binary selection maps suppress outliers, which allows us to use smaller smoothing kernels in the second step. We found that the smoothing step of the initial error estimate is necessary to obtain sufficiently discriminatory binary maps.

### Extensions

Adaptive Sampling. We follow the adaptive sampling strategy proposed by RousseIle at al. which we summarize here. We distribute samples over multiple iterations, each having an equal share of the sample budget. The first iteration performs uniform sampling, and the subsequent ones perform adaptive sampling. In the adaptive iterations, the sampling density is proportional to the estimated relative MSE returned by SURE, scaled by a weight W. The weight W represents the error reduction potential of a single sample, and accounts for the number of samples used in the filter, as well as the filter support,

$$W ( p ) = \frac{{\sum }_{q ∈ N ( p )} w ( p , q )}{1 + {n}_{p}} ,$$

where p is a pixel, N(p) the filter window around p, w(p, q) the weight of a neighbor q within the window, and n p the number of samples already contributing to the filtered value of p. The resulting weighted error is quite noisy, so we filter it aggressively with our fit function and parameters r=10, k_{c}=1.0, and k_{f}=∞. Lastly we clamp the number of samples allocated to each pixel to a fixed value to prevent spending too many samples on outliers.

Space-time Filtering for Animations. Filtering animations on a per-frame basis suffers from disturbing flickering artifacts due to low-frequency residual noise. We can greatly mitigate these problems by space-time filtering. We implement space-time filtering in our framework by extending our filtering window from a spatial to a spatiotemporal window across several frames, as proposed by Buades et al. Otherwise our algorithm remains the same as before. While there is hardly any noticeable difference on still frames, the spacetime filtered output exhibits significantly less flickering.

### 4. How to Use the Invention

In this invention, we presented a method for de-noising Monte Carlo renderings by constructing filters using a combination of color and feature information. We constructed three candidate filters based on NL-means weights for color buffers and cross bilateral weights for feature buffers. We determined robust averaging weights of the three candidate filters on a per pixel basis using SURE error estimation. We also introduced a novel approach to dealing with noisy features using a pre-filtering step, and we apply it to new caustics and visibility features. Together, candidate filter weighting including color information, feature pre-filtering, and the novel caustics and visibility features provide significant improvements in terms.

This invention can primarily be used to speed up rendering speed and quality for pre-visualization, handle depth of field, motion blur and even for final rendering, provided the “right” sample size is chosen for various targeted applications. The one limitation the algorithm has is for very low sampling rates, typically less than 10 samples per pixel, the color weights tend to become less useful and SURE-error estimation less reliable because of excessive variance in the color buffer. In such situations it is possible that our final filter using candidate filter averaging fails to improve the global MSE over the best candidate filter. At such low sampling rates it also becomes challenging to pre-filter noisy features such as the visibility. In these cases the filter parameters need to be adjusted to obtain reasonable results. This invention can be used to generate plug-ins for commercial Monte Carlo based rendering software systems, to enable them run faster and with better output quality. Furthermore, this invention will work for various image types, 2D and 3D rendering and CPU as well GPU architectures of computing systems.

### 5. Examples of the Invention

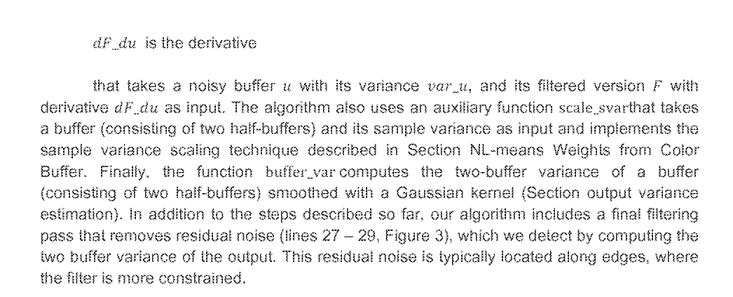

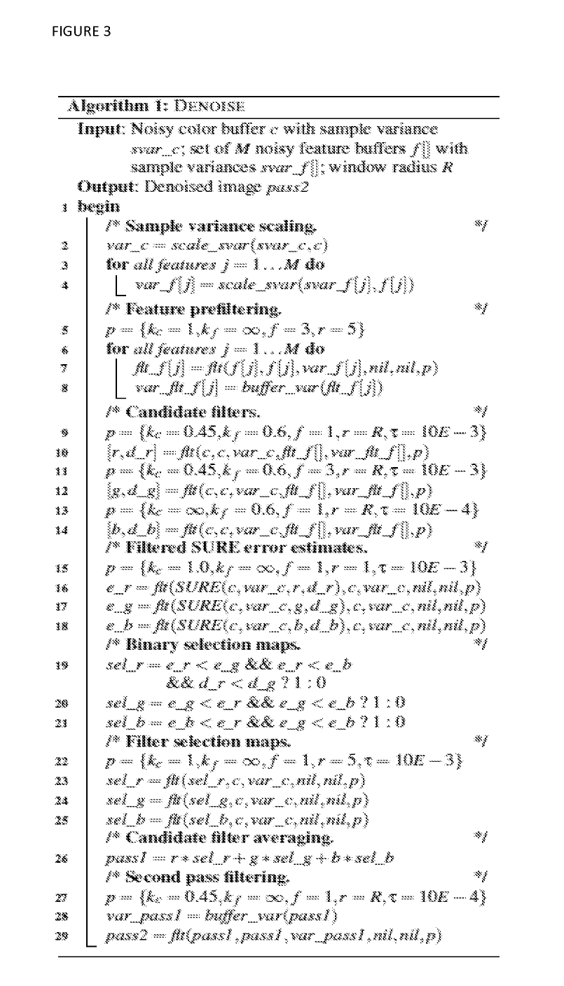

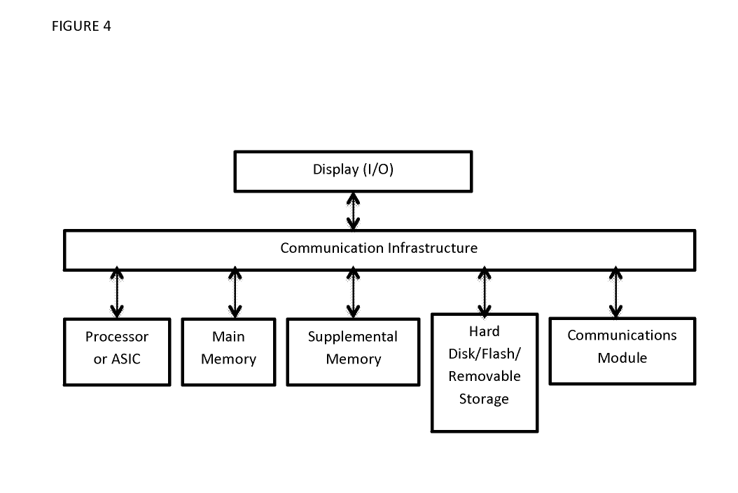

We integrated our method as an extension of the PBRT rendering framework and implemented the filtering operations themselves in CUDA for GPU acceleration. The complexity of each filtering step is proportional to image resolution, window radius f, and patch radius r. For an image resolution of 1024×1024 pixels and user specified window radius r=10, the complete filtering pipeline summarized in Algorithm (FIG. 3) takes 5.4 seconds on an NVidia GeForce GTX TITAN GPU, and 8.0 seconds on a Geforce GTX 580 GPU. All timings reported below were measured on a workstation with dual 6-core Intel Xeon processor at 2.3 GHz, 12 rendering threads, and a Geforce GTX TITAN GPU.

We also developed a CPU implementation that fully exploits multi-core CPUs using multithreading. This implementation is integrated into the PBRT rendering system exactly like the GPU approach described above. The filter operation and output is equivalent to the GPU version. Even on modern CPUs with two dozen threads or more, however, the computation time of the CPU implementation is an order of magnitude larger than for the GPU version.

1. A robust de-noising system using feature and color information comprising the steps of:
Implementing a software algorithm that post-processes the output of a Monte Carlo renderer;
taking the noisy image produced by a Monte Carlo renderer and applying a filter to reduce noise;
reducing the error of the filtered image compared to the unfiltered image by a factor of more than five in most scenarios; and
reducing the render time to obtain an image with equal error compared to unfiltered Monte Carlo output by a factor of more than five in most scenarios.

2. A method of performing robust de-noising according to claim 1 that uses combined color and feature buffers to improve image space de-noising of Monte Carlo renderings.

3. A method of performing robust de-noising according to claim 1 that uses NL-means and cross-bilateral filtering, and a SURE-based error estimate.

4. A method of performing robust de-noising according to claim 1 that computes a weighted average of several candidate filters on a per-pixel basis using a SURE-based error estimate to minimize the output error.

5. A method of performing robust de-noising according to claim 1 that controls the influence of color and feature buffers by adjusting the parameters of the NIL-means and bilateral filters.

6. A method of performing robust de-noising according to claim 1 that combine color and feature information, evaluating three candidate filters using different parameters designed to provide a trade-off between fidelity to image detail and robustness to noise.

7. A method of performing robust de-noising according to claim 1 that uses de-noising as a separate step to deal with noisy features.

8. A method of performing robust de-noising according to claim 1 that uses the novel features such as caustics and direct visibility.

9. A method of performing robust de-noising according to claim 1 that extends the application to adaptive sampling and space-time filtering for animations.

10. A method of performing robust de-noising according to claim 1 that splits Monte Carlo samples into several buffers.

11. A method of performing robust de-noising according to claim 1 that estimates the variance of pixels in the Monte Carlo output using several buffers.

12. A method of performing robust de-noising according to claim 1 that estimates the variance of pixels in the Monte Carlo output by filtering the squared difference between two buffers, using this to scale the Monte Carlo sample variance, and taking the scaled Monte Carlo sample variance as the estimate of the pixel variance.

13. A method of performing robust de-noising according to claim 1 that uses the estimated variance of the pixels in the Monte Carlo output to derive color filter weights.

14. A method of performing robust de-noising according to claim 1 that uses the estimated variance of the pixels in the Monte Carlo output to compute weights of an NL-means filter.

15. A method of performing robust de-noising according to claim 1 that computes feature filter weights by including derivatives of the features in the weight computation.

16. A method of performing robust de-noising according to claim 1 that combines color and feature filter weights by taking the minimum of the two at each pixel.

17. A method of performing robust de-noising according to claim 1 that filters several buffers containing noisy Monte Carlo output separately.

18. A method of performing robust de-noising according to claim 1 that estimates the variance of the filtered output by computing the variance over the filtered buffers.

19. A method of performing robust de-noising according to claim 1 that applies a second filtering pass using the estimated variance of the output of the first pass to construct filter weights.

20. A method of performing robust de-noising according to claim 1 that removes noise in the output of the per pixel SURE error estimator.

21. A method of performing robust de-noising according to claim 1 that removes noise in the output of the per pixel SURE error estimator by first generating binary filter selection maps, which are then filtered in a second step.

22. A method of performing robust de-noising according to claim 1 that combines the outputs of several candidate filters by computing a weighted average with continuous weights, where the weights are derived from smoothed binary selection maps for the candidate filters

23. A method of performing robust de-noising according to claim 1 that performs space time filtering by computing filter weights in a spatiotemporal neighborhood around each pixel for 2D images and 3D models.

24. A method of performing robust de-noising according to claim 1 that runs in a cloud server-based rendering environment and on any computing device such as a PC, Tablet, Smartphone, single-CPU server or a multi-CPU Server.
